(19) United States
(12) Patent Application Publication
(10) Pub. No.: US 2003/0074254 A1
(43) Pub. Date: Apr. 17, 2003

(54) Data collecting method

(75) Inventor: Junichi Iijima, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/102,815

(22) Filed: Mar. 22, 2002

(30) Foreign Application Priority Data
Oct. 11, 2001 (JP) 2001-314196

(51) Int. Cl. G06F 17/60

(52) U.S. Cl. 705/10

(57) ABSTRACT

The server of the commodity supplier receives the transaction number printed on the receipt held by the consumer who purchased the specific commodity from the terminal of the consumer, and extracts the transaction data having the commodity information in all the commodities sold in a sales processing corresponding to the transaction number from the transaction database accumulated in the POS system of the shop. Therefore, procuring the information (related purchase information) in the other commodities purchased along with the specific commodity.

### BACKGROUND OF THE INVENTION

1. Field of the Invention

The present invention relates generally to a data collecting method capable of collecting related purchase information on which commodities are purchased along with a specific commodity purchased, and more particularly to a data collecting method utilizing a POS system introduced into shops.

2. Description of the Related Art

In shops, etc., a POS (Point of Sales) system managing commodity sales information is prevailing. The POS system is called a sales point-of-sales information managing system, and can collect sales information such as selling location, date and time, volume, and the like in commodity one item unit, and collects, accumulates and analyzes the sales information in each commodity, thereby promptly grasping a sales trend of each commodity. Furthermore, the such-obtained sales information can be used for sales management, inventory management, procurement management, or the like.

Furthermore, for marketing activities such as commodity development, sales support (inclusive of advertisements, etc.) or the like, a commodities supplier (for example, a maker, a distributor, or the like) which supplies commodities to the shop also obtains the sales information from the shop, and analyzes the sales information, and makes a marketing analysis of the sales trend of the commodity which its own company handles.

However, the sales information that the commodities supplier ordinarily acquires from the shop is sales information (sales time, sales location, sales number-of-commodities, etc.) of the specific commodity per se which the commodity supplier handles, and therefore information (related purchase information) of the other commodities that a consumer purchased along with the specific commodity is still indistinct. An analysis of this related purchase information is also called a basket analysis, which can be utilized for advertisements of commodities, display locations of commodities in the shop, or the like. For example, a refrigerant maker as the commodity supplier publishes the advertisements of the refrigerant in magazines to be with high frequency purchased along with its own company's refrigerant, so that the effective advertisements function.

On the other hand, the commodity supplier carries out a present campaign, etc. and at that time has the consumers reply to a questionnaire, thereby occasionally examining the consumers' matters of concern and consumption trend. For example, the consumer collects the necessary number of an entry coupon (necessary points) affixed to its own company's commodity (or incorporated in a wrapping paper), and affixes it to a specific entry printed create, and mails it to the commodity supplier along with a replay to the questionnaire to enter therefor.

However, the questionnaire to be carried out in the present campaign, etc. is generally purchase conditions of the commodity and impressions on the commodity, and does not request the consumer to reply to the related purchase information such as commodity name purchased together.

### SUMMARY OF THE INVENTION

It is therefore the object of the present invention to provide a data collecting method capable of collecting information (related purchase information) on commodities purchased along with a specific commodity.

In order to achieve the above object, according to an aspect of the present invention, there is provided a data collecting method for collecting data on other commodities sold along with a specific commodity, comprising the steps of: by means of a POS terminal of a shop, executing sales processing of a plurality of commodities including the specific commodity, issuing a receipt on which a transaction identifier (transaction number, for example) of the sales processing and an entry coupon associated with the specific commodity are printed, creating a transaction data including at least the transaction identifier and a data on the plurality of commodities sold by the sales processing, and accumulating the transaction data in a transaction database connected to the POS terminal via a network; and by means of a server, accepting, via the network, entry information which is sent from a terminal of a consumer having the receipt and which includes contents of the transaction identifier and of the entry coupon printed on the receipt, making an access to the transaction database, and acquiring, from the transaction database, the transaction data corresponding to the transaction identifier included in the entry information.

In this manner, a server of the commodity supplier receives a transaction number printed on a receipt held by a consumer who purchased a specific commodity from a terminal of the consumer, and extracts transaction data having commodity information in all commodities sold through a sales processing corresponding to the transaction number from a transaction database accumulated in a POS system of a shop, whereby the server can obtain information (related purchase information) in the other commodities purchased along with the specific commodity.

### BRIEF DESCRIPTION OF THE DRAWINGS

The above and other objects, aspects, features and advantages of the present invention will become more apparent from the following detailed description when taken in conjunction with the accompanying drawings, in which:

FIG. 1 is a diagram showing a system configurational example for carrying out a data collecting method according to an embodiment of the present invention;

FIG. 2 shows a configurational example of transaction data on each transaction;

FIG. 3 is a schematic flowchart of a data collection process according to the embodiment of the present invention;

FIG. 4 shows an example of data on commodity information;

FIG. 5 is a flowchart of an issuance of a receipt on which an entry coupon is printed;

FIG. 6A and FIG. 6B show examples of the receipt on which the entry coupon is printed;

FIG. 7 shows an example of a screen of an entry site provided by a commodity supplier; and

FIG. 8 is a diagram showing a sample of a data configuration of a related purchase information database.

### DESCRIPTION OF THE PREFERRED EMBODIMENT

A preferred embodiment of the present invention will now be described. It is to be understood that the technical scope of the present invention is not limited to the embodiment.

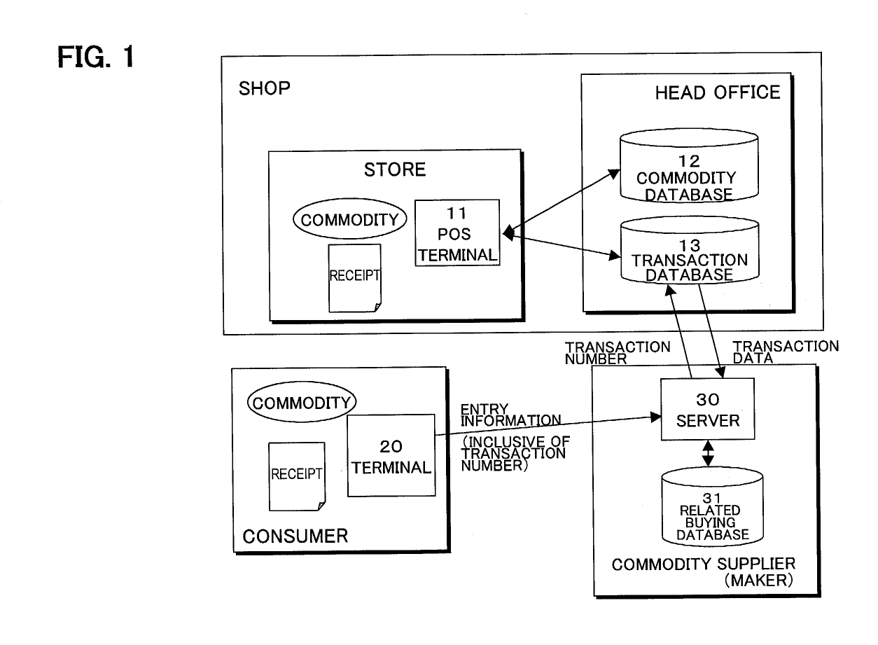

FIG. 1 is a diagram showing a system configurational example for carrying out a data collecting method according to an embodiment of the present invention. In FIG. 1, the data collecting system is constituted by a POS system 10 introduced into a shop, a terminal 20 to be used by a consumer who will purchase a commodity, and a network server 30 to be administered by a commodity supplier (for example, a maker).

The POS system 10 has a POS terminal 11 like a cash register which is arranged in accommodations of a shop and carries out sales processing of commodities to be purchased by a customer; a commodity database which stores commodity information such as commodity name, selling price and the like of each commodity; and a transaction database which stores transaction data on a commodity selling transaction. The POS terminal 11 reads a commodity attached bar code by, for example, a bar code reader from its selling transaction function, and accesses the commodity database 12, and obtains commodity information (commodity name, selling price, and the like) corresponding to its bar code information (commodity code) from the commodity database 12 to sales-register, and finally prints a receipt to issue. Transaction data (transaction number, transaction time, commodity name, selling price, volume, and the like) created by a one-time sales processing are temporarily stored in the POS terminal 11, and are collectively transmitted to the transaction database 13 when executing a reckoning transaction to be reckoned on the day after closing the shop, to be stored therein.

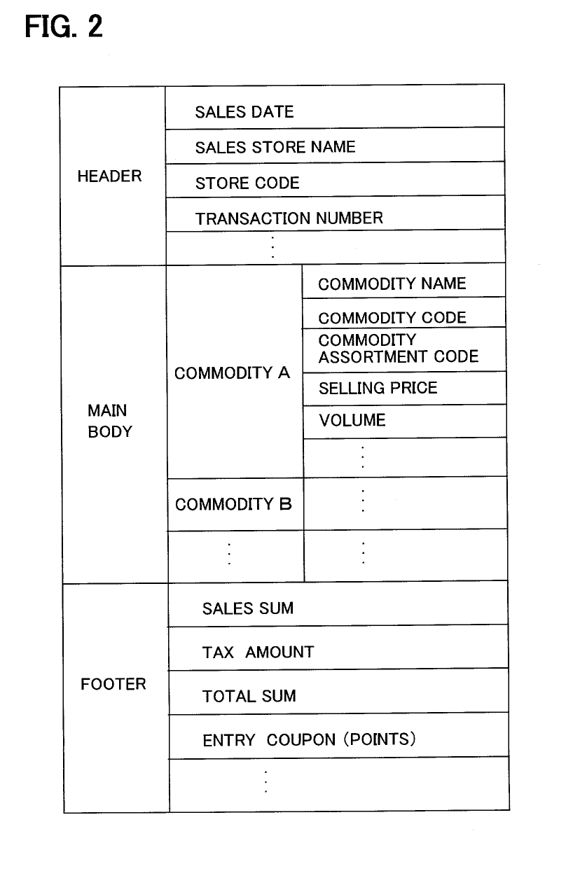

FIG. 2 is a configurational example of transaction data on each transaction. In FIG. 2, the transaction data have a header including sales date, sales store name, store code and transaction number (transaction identifier); main body data including commodity title, commodity code, commodity assortment code, selling price, volume of each commodity; and a footer including sales sum (subtotal sum), tax total, total sum obtained by reckoning up the subtotal sum and tax amount, further points of an entry coupon to be described later.

With the above-described configuration, according to this embodiment, a network server 30 of the commodity supplier obtains the transaction number printed on the receipt in such a transaction that its commodity supplier sold its own company's commodity by a notification of a consumer holding the receipt, and accesses the transaction database 13 of the POS system 10 to obtain the transaction data corresponding to the transaction number from the transaction database 13. As the transaction data corresponding to the transaction number include all the commodity information such as commodity name and the like sold in the transaction in relation to the transaction number, the commodity supplier can procure the commodity information (related purchase information) in the other commodities purchased along with the own company's commodity.

In order for the consumer to notify the commodity supplier of the transaction number, the commodity supplier executes a present campaign of money or premium relating to the own company's commodities. Needless to say, the present campaign may be carried out for the purpose of a sales promotion of the own company's commodities (campaign targeting commodities). In the present campaign, the entry coupon for the consumer's entering for the campaign is printed on the receipt of the transaction which sold the present campaign targeting commodity by the POS terminal 11 of the shop. The commodity supplier accepts the consumer's entry via a network like the Internet, and upon the entry, is notified of the transaction number of a receipt having an entry coupon printed thereon from the consumer, so that the transaction number can be obtained.

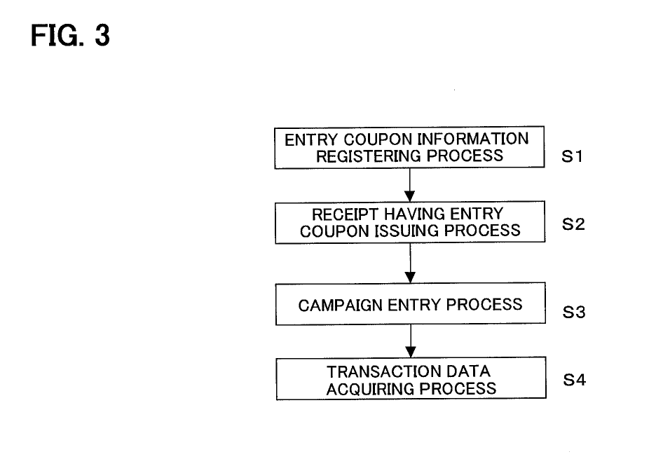

FIG. 3 is a schematic flowchart of a data collection process according to the embodiment of the present invention. First of all, entry coupon information required for issuing the entry coupon is registered as the commodity information regarding the present campaign targeting commodities in the commodity database 12 of the POS system 10 (entry coupon information registering process: S1). The entry coupon information is flag information for judging whether to print the entry coupon, campaign period, points and the like, for example.

The POS terminal 11 issues the receipt on which the entry coupon is printed in accordance with the entry coupon information in the commodity database 12 regarding a commodity sales processing including the campaign targeting commodity (receipt having entry coupon issuing process: S2).

When entry conditions are satisfied (for example, when the total of points of the entry coupons respectively printed on a plurality of receipts reaches a specific point), the consumer utilizes the terminal 20 of a personal computer to access an entry acceptance site presented by the server 30 administered by the commodity supplier on the network like the Internet, and inputs entry information (name, address, phone number, points of the entry coupon, transaction number and the like) required for the entry, to thereby make an entry (campaign entry process: S3).

When the server 30 receives the entry information, the server 30 accesses the transaction database 13 of the POS system 10 of the shop to acquire transaction data in accordance with the transaction number from the transaction database 13 (transaction data acquiring process: S4). In this manner, the transaction number of the receipt by which the campaign targeting commodity (its own commodity) is sold is acquired by a notification from the consumer, so that it is possible to extract the transaction data corresponding to the transaction number from the transaction database 13. Therefore, the commodity supplier can collect information (related purchase information) of the other commodities purchased along with the campaign targeting commodity.

Hereinafter, the respective process steps will be described in detail.

(Entry Coupon Information Registering Process: S1)

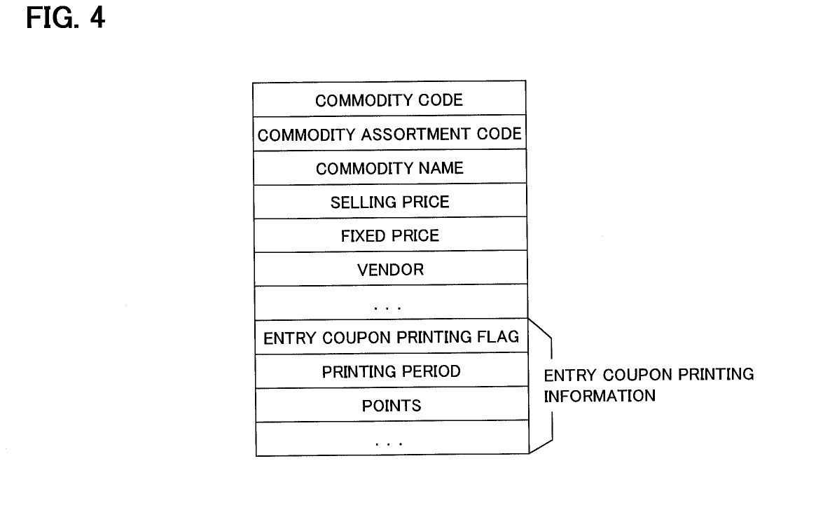

FIG. 4 is an example of data on the commodity information. As shown in FIG. 4, the commodity information has commodity code, commodity assortment code, commodity name (formal title, receipt printing title, etc.), selling price, fixed price, vendor, and the like, and further includes, as the entry coupon printing information, entry coupon printing flag (flag ON) for judging whether to be an entry coupon printing targeting commodity, period to be printed (or campaign period), points with respect to a sale of a piece of commodity, and the like.

When the commodity supplier determines a present campaign executing gist, the commodity supplier notifies the shop of campaign contents including the entry coupon printing information. When the shop receives the entry coupon printing information from the commodity supplier, the shop additionally registers the entry coupon printing information to the commodity information of the campaign targeting commodity in the commodity database 12 of the POS system 10 of the shop.

(Receipt Issuing Process: S2)

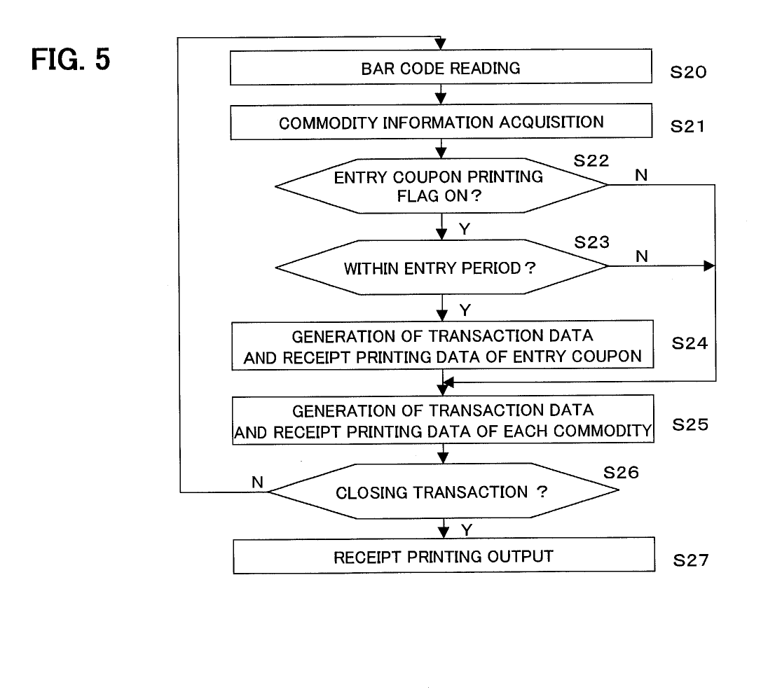

FIG. 5 is a flowchart of an issuance of the receipt on which the entry coupon is printed. In FIG. 5, the POS terminal 11 arranged in accommodations of the shop reads a bar code attached to the commodity by a bar code reader (S20). Incidentally, the POS terminal 11 issues the transaction number by a first commodity reading process. The POS terminal 11 accesses the commodity database to refer to the commodity information corresponding to the read bar code information (commodity code) to obtain commodity name, selling price and the like (S21), and creates (generates) the transaction data (commodity code, commodity name, selling price, volume and the like), and receipt printing data (commodity name, selling price, volume) of the commodity corresponding to the transaction number, respectively, and stores the data in a memory in the POS terminal 11 (S25). Furthermore, when the POS terminal 11 refers to the entry coupon printing information in the commodity information and instructs to print the entry coupon according to the entry coupon printing information, namely, when the POS terminal 11 judges whether or not the entry coupon printing flag is ON (S22), and this corresponds to the case where the entry coupon printing flag is ON, and further when the POS terminal 11 judges whether to be within the campaign period (S23), and this corresponds to within the campaign period, the POS terminal 11 stores the transaction data and receipt printing data of the entry coupon of points corresponding to the volume of such commodities bought out in the memory (S24). When there are a plurality of commodities bought out, the sales registering processes in steps S20 to S25 are repeated regarding the respective commodities.

When the sales registering processes regarding each commodity are ended and an operator of the POS terminal 11 carries out a closing operation, the POS terminal 11 executes a closing process (S26). That is, the POS terminal 11 calculates a sales sum as the total of selling prices of each commodities, a tax amount thereon, the total of the tax amount and sales sum, and the total of the points of entry coupon printing instruction data, and stores respective calculated values in the memory as the transaction data and receipt printing data corresponding to the transaction number. The POS terminal 11 prints the receipt printing data stored in the memory in the POS terminal 11 on the receipt to output it (S27). At this time, the total points of the entry coupon printing instruction data are printed in a specific region of the receipt as the entry coupon including the total points.

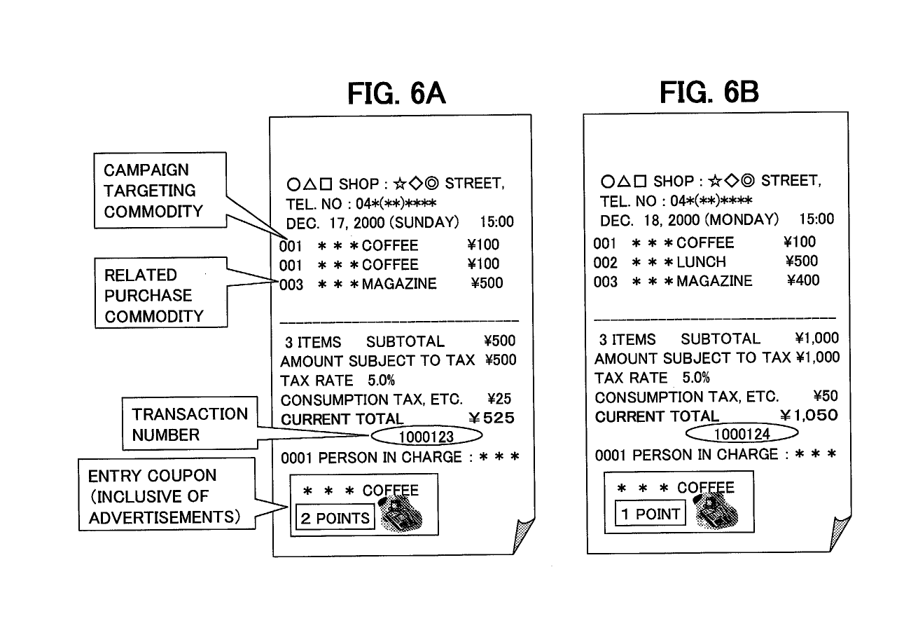

FIG. 6A and FIG. 6B show examples of the receipt on which the entry coupon is printed. As shown in FIG. 6A and FIG. 6B, the title, selling price, various total sums and transaction number of the purchased commodity as well as the entry coupon are printed on the receipt. FIG. 6 A and FIG. 6B show the case where “*** coffee” is a present campaign targeting commodity and the entry coupon of one point is allocated whenever such commodity may be purchased one by one, and in FIG. 6A, as such commodity is sold in two, the points of the entry coupon are two, and in FIG. 6B, as such commodity is sold in one, the point of the entry coupon is one.

Furthermore, when a reckoning transaction for reckoning on the day is executed after the store is closed, the transaction data on each sales processing are collectively transmitted from the POS terminal 11 to the transaction database 13 to be accumulated therein.

(Campaign Entry Process: S3)

When the consumer collects the receipts issued in such a manner and the points reach the entry conditions, the consumer utilizes the terminal 20 like the personal computer to enter. Specifically, the consumer operates the terminal 20 to access an entry site provided on the network like the Internet by the server 30 of the commodity supplier, so that the entry site is displayed on a screen of the terminal 20. The consumer inputs the predetermined entry information through the entry acceptance site screen, and transmits it to the server 30.

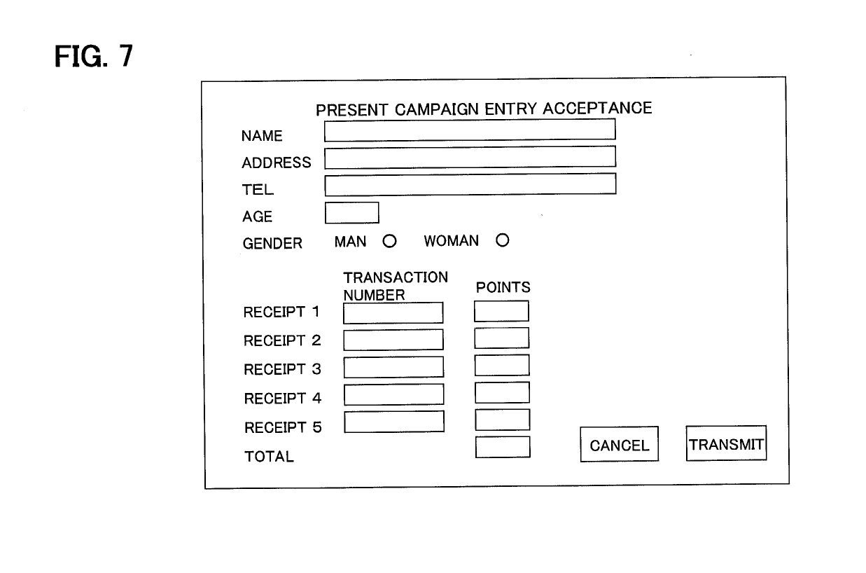

FIG. 7 is a sample of the screen of the entry acceptance site provided by the commodity supplier. As shown in FIG. 7, the consumer inputs, as entry information, personal information such as at least name, age, gender, address and phone number, transaction number printed on the receipt, and the points of the entry coupon printed on the receipt. When the total points of the entry coupon of the plurality of receipts satisfy the entry conditions, the consumer inputs the transaction number and the points of the entry coupon in each receipt, respectively. Furthermore, as a questionnaire, there may be an input column (not shown) such as hobby, family member or the like.

(Transaction Data Acquiring Process: S4)

When the network server 30 of the commodity supplier receives the entry information transmitted from the network terminal 20 of the consumer, the server 30 accesses the transaction database 13 of the POS system 10 of the shop to obtain the transaction data corresponding to the transaction number included in the entry information from the transaction database 13, thereby constructing the related purchase information database 31.

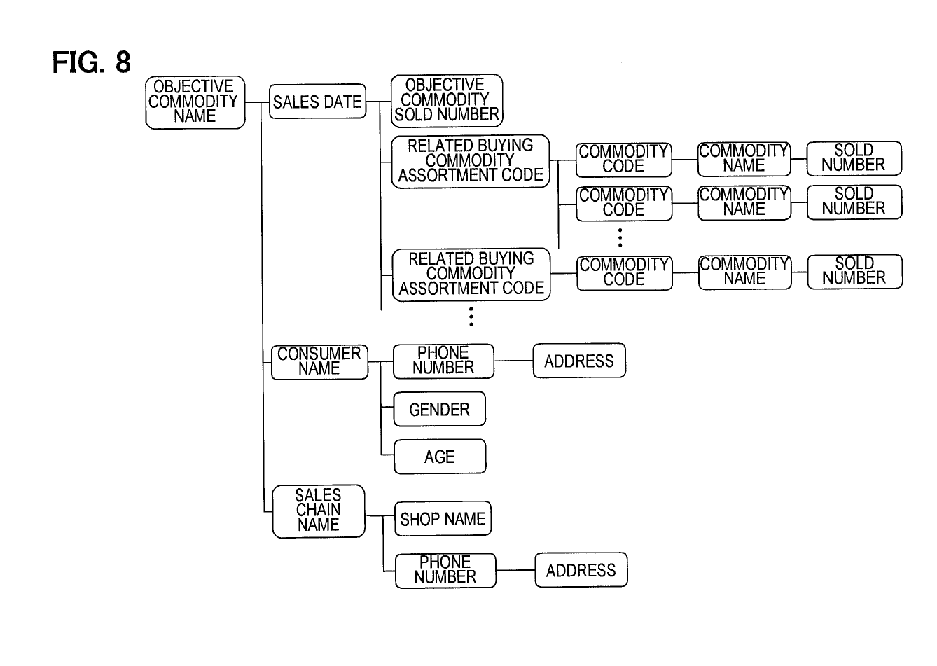

FIG. 8 is a diagram showing a sample of a data configuration of the related purchase information database 31. In FIG. 8, the related purchase information database 31 is an aggregation of data in each transaction unit, and is, as exemplified in FIG. 8, constructed as a database associated with information in the commodities (sales data and information belonging thereto), and information in the consumer (entrant) (consumer name and information belonging thereto (address, age, gender, etc.)), and more preferably, information in the shop (sales chain name and information belonging thereto (shop name, address, etc.)). In particular, the information in the commodities is information (assortment code, commodity code, commodity name, the number of commodities sold and the like) in the number of campaign targeting commodities sold, and the commodities sold along with the campaign targeting commodities (related buying commodities).

By constructing such the related purchase information database 31, the commodity supplier analyzes the related purchase information of the targeting commodity, and utilizes it for marketing activities. For example, based on the analysis of the related purchase information, the advertisements of the targeting commodity are published in magazines which are purchased along with the targeting commodity with high frequency, so that the effective advertisements are enabled. Furthermore, the commodity supplier guides the shop to bring the targeting commodity within the store near the commodities which may be purchased along with the targeting commodity with high frequency in disposition, so that the effective shop support activities are enabled.

Incidentally, when the server 30 of the commodity supplier receives the entry information from the consumer's terminal 20, and obtains the transaction data corresponding to the transaction number included therein from the transaction database 13 of the POS system 10, the server 30 collates the points of the entry coupon in each transaction number included in the entry information with the points included in the transaction data of the corresponding transaction number. This is done for checking the accuracy in the points which are self-reported by the consumer.

Hereinabove, according to the present invention, the server of the commodity supplier receives the transaction number printed on the receipt held by the consumer who purchased the specific commodity from the terminal of the consumer, and extracts the transaction data having the commodity information in all the commodities sold in a sales processing corresponding to the transaction number from the transaction database accumulated in the POS system of the shop, thereby procuring the information (related purchase information) in the other commodities purchased along with the specific commodity.

While the illustrative and presently preferred embodiment of the present invention has been described in detail herein, it is to be understood that the inventive concepts may be otherwise variously embodied and employed and that the appended claims are intended to be construed to include such variations except insofar as limited by the prior art. The protective scope of the present invention is not limited to the above embodiment but covers the invention defined by claims and its equivalents.

What is claimed is:

1. A data collecting method for collecting data on other commodities sold along with a specific commodity, comprising the steps of:
by means of a POS terminal of a shop, executing sales processing of a plurality of commodities including the specific commodity, issuing a receipt on which a transaction identifier of the sales processing and an entry coupon associated with the specific commodity are printed, creating a transaction data including at least the transaction identifier and a data on the plurality of commodities sold by the sales processing, and accumulating the transaction data in a transaction database connected to the POS terminal via a network; and
by means of a server, accepting, via the network, entry information which is sent froma terminal of a consumer having the receipt and which includes contents of the transaction identifier and of the entry coupon printed on the receipt, making an access to the transaction database, and acquiring, from the transaction database, the transaction data corresponding to the transaction identifier included in the entry information.

2. A data collecting method according to claim 1, wherein the POS terminal in the sales processing makes an access to a commodity database that accumulates commodity information corresponding to a commodity code of each of the plurality of commodities, to acquire commodity information corresponding to the commodity code of the specific commodity, and
if entry coupon print instruction information is included in the commodity information of the specific commodity, then the POS terminal prints the entry coupon on the receipt.

3. A data collecting method according to claim 1, wherein
the entry information further includes data on the consumer, and wherein
the server creates a database which the data on the plurality of commodities included in the transaction data is associated with a data on the consumer included in the entry information.

4. A data collecting method according to claim 1, wherein
the data on the plurality of commodities included in the transaction data has at least a commodity name or a commodity code of each of the plurality of commodities.

5. A data collecting system for collecting data on other commodities sold along with a specific commodity, comprising:
a POS terminal which executes sales processing on sales processing of a plurality of commodities including the specific commodity, issues a receipt on which a transaction identifier of the sales processing and an entry coupon associated with the specific commodity are printed, and creates a transaction data including at least the transaction identifier and a data on the plurality of commodities sold by the sales processing;
a transaction database which receives and accumulates the transaction data from the POS terminal; and
a server which accepts, via a network, entry information which is sent from a terminal of a consumer having the receipt and which includes contents of the transaction identifier and of the entry coupon printed on the receipt, makes an access to the transaction database, and acquires, from the transaction database, the transaction data corresponding to the transaction identifier included in the entry information.

6. A data collecting system according to claim 5, wherein
the POS terminal in the sales processing makes an access to a commodity database that accumulates commodity information corresponding to a commodity code of each of the plurality of commodities, to acquire commodity information corresponding to the commodity code of the specific commodity, and
if entry coupon print instruction information is included in the commodity information of the specific commodity, then the POS terminal prints the entry coupon on the receipt.

7. A data collecting system according to claim 5, wherein
the entry information further includes data on the consumer, and wherein
the server creates a database which the data on the plurality of commodities included in the transaction data is associated with a data on the consumer included in the entry information.

8. A data collecting method according to claim 5, wherein
the data on the plurality of commodities included in the transaction data has at least a commodity name or a commodity code of each of the plurality of commodities.
